(19) United States
(12) Patent Application Publication
(10) Pub. No.: US 2016/0097951 A1
(43) Pub. Date: Apr. 7, 2016

(54) A MOUNTING STRUCTURE AND METHOD OF DIRECT TYPE BACKLIGHT MODULE LIGHT BAR AND THAT OF LIQUID CRYSTAL DISPLAY

(71) Applicant: SHENZHEN CHINA STAR OPTOELETRONICS TEECHNOLOGY CO., LTD., Shenzhen ,Guangdong (CN)

(72) Inventors: Yi Cheng KUO, Shenzhen, Guangdong (CN); Yuchun HSIAO, Shenzhen, Guangdong (CN); Yanxue ZHANG, Shenzhen, Guangdong (CN)

(21) Appl. No.: 14/008,145

(22) PCT Filed: Jun. 29, 2013
(86) PCT No.: PCT/CN2013/078521

§ 371 Date: Sep. 27, 2013

(30) Foreign Application Priority Data
Jun. 21, 2013 (CN) 201310250726.6

(51) Int. Cl. G02F 1/1335

(52) U.S. Cl. CPC G02F 1/133603; G02F 2001/133612

(57) ABSTRACT

A mounting structure of direct type backlight module light bar comprising a PCB and a plurality of light bars, wherein, two PCB circuit strips are assembling at the two edges of the PCB, the PCB circuit strips are provided with a plurality of the first connectors assembled on, the light bars are provided with a plurality of the second connectors assembled on. The PCB circuit strips can be uniformly storied and sorted out of the wire of the light bar to make the wire to be in order. The light bars can be inserted into the PCB circuit strips with the connectors for achieving the fast assembling and disassembling of the light bars. The circuit can be simplified, so the light emitting modules can be fast disassembled or assembled, and the mounding efficiency of the backlight module light bar and the rate of the good product will be improved.

### FIELD OF THE INVENTION

The present invention relates to the liquid display technology, and more particularly to a mounting structure of the backlight module light bar and that of liquid crystal display.

### BACKGROUND OF THE INVENTION

With the development of the liquid display technology, the large liquid display module becomes an advancing tendency. Refer to FIG. 1, owing to a number of the light-bars 30 assembled at the PCB circuit strips, so that the circuit is complicated, the light bars are respectively leaded from the PCB so that the circuit is in disorder and easy to mistake assemble. Accordingly, the mounting efficiency and the rate of the good product are lower.

Therefore, it is necessary to provide a mounding structure of backlight module light bar with high mounding efficiency and easily disassembling.

### SUMMARY OF THE INVENTION

According to the disadvantages of the prior art, the major purpose of the present invention is to provide a mounting structure and method of direct type backlight module light bar to prevent the light bar circuit in disorder and disassembling, so as to improve the mounding efficiency and the rate of good product. In addition, the present invention also provides a liquid crystal display comprising the mounting structure.

For achieve the about purpose, the present invention provide a mounting structure of direct type backlight module light bar comprising a PCB and a plurality of light bars, wherein, two PCB circuit strips are provided for assembling at the two edges of the PCB, the PCB circuit strips are provided with a plurality of the first connectors assembled on. The PCB circuit strips are provided for connecting the light bar to the PCB for easy to sort out and butt-joint.

Perfectly, the light bars are provided with a plurality of the second connectors assembled on. The inputting and the outputting of the light bars assembled on the PCB circuit strips with the first connectors are connecting with the second connectors accordingly. Accordingly, the light bar can be fast assembled and disassembled from the PCB. The first connectors and the second connectors can be identified to butt-joint for preventing the mistake assembling of the light bar and improving the rate of the good product. With the butt-jointing between the first connector and the second connector, the efficiency of assembling and disassembling light bar is improved, and thus the manufacture efficiency is enhanced.

Perfectly, the first connectors are electrically connecting on the PCB with a plurality of wires run through the PCB circuit strips. In the PCB circuit strips, the wires are connecting to the PCB after leading and arranging. Then the efficiency of wiring is improved. It is not necessary that the light bars are leading on the PCB via wires respectively. Then the wire of the PCB will in order.

Perfectly, the distance between every two light bars is equal. The distance between two adjoining light bars is 52-58 mm. The light bars are assembled at the same side of the PCB circuit strip for easy to insert the light bar.

Perfectly, the light emitting modules are electrically connecting in series to each other. And the first connectors of the PCB circuit strip are electrically connecting in series or in parallel to each other.

Perfectly, the PCB circuit strips are assembled at the edges of the PCB. The number of the PCB circuit strips can be changed on the edge of the PCB for fast assembling or disassembling demand, so that the circuit of the PCB will be simplified.

Another purpose of the present invention is provided for a mounting method of the mounting structure of direct type backlight module light bar, wherein comprising the following processes:

Step 1) Inserting and connecting the plurality of light emitting modules into the light bars;

Step 2) Welding the several groups light bars on the PCB;

Step 3) Electrically connecting the inputting and the outputting of the light bars to the PCB circuit strips with the first connectors of the PCB circuit strips and the second connectors of the light bars correspondingly connecting, and then achieve the mounting structure of backlight module light bar.

Another purpose of the present invention is provided for a liquid crystal display comprising a mounting structure of direct type backlight module light bar.

Compared to the prior art, the mounting structure of direct type backlight module light bar of the present invention comprises a PCB circuit strip separated from the PCB for storing the wire of the light bars uniformly. The wires which electrically connecting the light bars will be in order. The light bars can be electrically connecting to the PCB circuit strip with the connectors for achieving the fast assembling and disassembling of the light bars. The light bars can be illumined together. At the same time, each connector can be identified for the accurate assembling of the light bars. The light bar can be assembled on the PCB circuit strip correspondingly. With the uniform wiring, the circuit of the PCB can be simplified, so the light emitting modules can be fast disassembled or assembled, and then the mounding efficiency of the backlight module light bar and the rate of the good product will be improved.

### BRIEF DESCRIPTION OF THE DRAWINGS

FIG. 1 is a schematic view showing the mounting structure of direct type backlight module light bar of the prior art;

FIG. 2 is a schematic view showing the mounting structure of direct type backlight module light bar of the present invention;

FIG. 3 is an amplify view showing the A-area of the mounting structure of direct type backlight module light bar of the present invention; and

FIG. 4 is a side view showing the mounting structure of direct type backlight module light bar of the present invention.

### DETAILED DESCRIPTION OF THE PREFERRED EMBODIMENTS

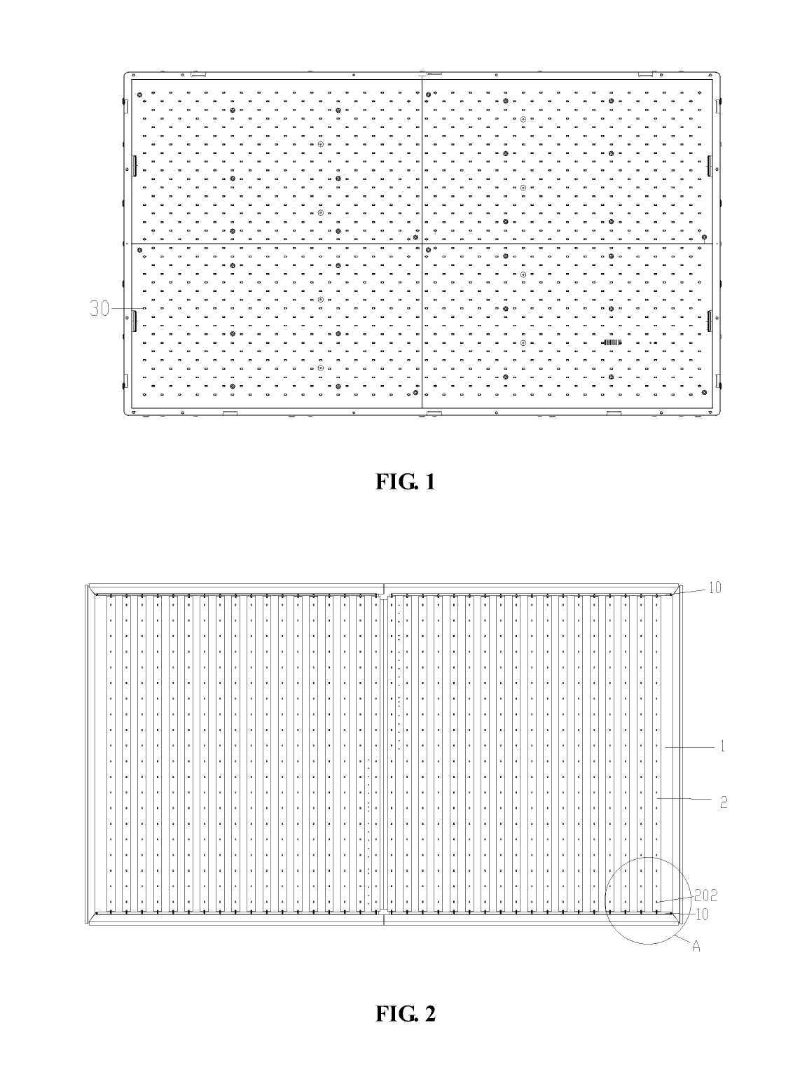

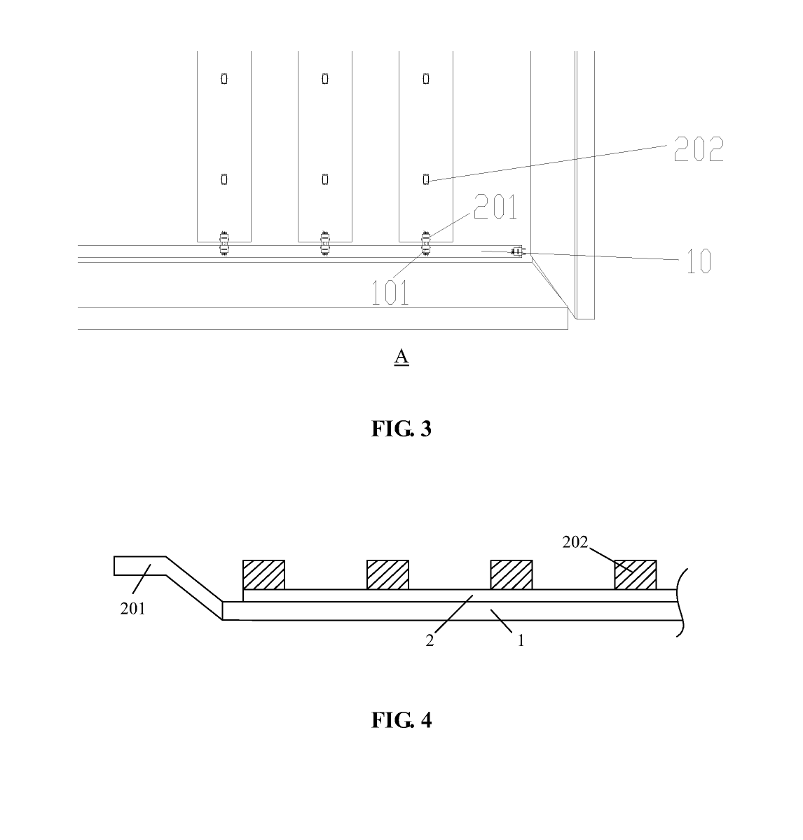

Refer to FIGS. 2-4, for solving the problem of the wires be in disorder or mistake assembled, the present invention provided a mounting structure of direct type backlight module light bar, comprising a PCB 1 and a plurality of light bars 2, wherein, two PCB circuit strips 10 are assembled at the two edges of the PCB 1. The inputting and the outputting of the light bars 2 are electrically connecting with the PCB circuit strips 10. A plurality of the first connectors 101 are assembled on the PCB circuit strips 10, the light bars 2 can be assembled on the PCB circuit strips 10 by the first connector 101. Then the light bars 2 are assembled to the PCB 1.

The PCB circuit strip 10 is provided for uniformly connecting a plurality light bars 2, which is assembled at the inputting or the outputting of the PCB respectively. The outputting of the PCB can also be electrically connecting to the power via the wires. For the light bars 2 connecting conveniently, the first connectors 101 on the PCB circuit strips 10 are electrically connecting to the PCB by the plurality of wires through the PCB circuit strips 10. That is to say, the PCB circuit strips 10 are provided for storing the wires of the light bar 2 and the PCB orderly, so as to make the light bars 2 not necessary to connect to the PCB alone and not be confused with the other wires. The wires are to be easily sorted out and the light bar 2 is easily assembled or disassembled. Perfectly, the distance of every two light bars 2 is equal to. In the present embodiment, the distance is 52-58 mm. The light bars 2 are assembled at the same side of the PCB circuit strip 10 for the light emitting modules conveniently connecting. The first connectors 101 of the PCB circuit strip are electrically connecting in series or in parallel to each other.

Perfectly, a plurality of the second connectors 201 are assembled on the edges of the light bars 2. When on assembling, the second connector 201 is correspondingly connecting to the first connector 101 with the male connector and the female connector butt-jointing, and then the light bars 2 are assembled at the PCB circuit strip 10. So the assembling or disassembling of the light bars 2 can be achieved. The model of the second connector 201 and the first connector 101 is the same. The first connectors are welded on the PCB circuit strip 10 and the second connectors are welded on the light bar 2 with the pins. After the butt-jointing of the second connector 201 and the first connector 101, the light bars 2 are in parallel to each other and the wires are in order for easy to assembly. The mounting structure will be not increase the thickness of the whole PCB. A plurality of light emitting modules 202 are installed on the light bar 2. The light emitting module can be selected of LED light. The light bars 2 are assembled on the back of the PCB 1.

Perfectly, the PCB circuit strips are assembled at the edges of the PCB 1. The number of the PCB circuit strips 10 can be changed for fast assembling or disassembling demand, so that the circuit of the PCB will be simplified and the mounding efficiency will be improved. At the same time, the problem can be solved that the wires in PCB or around the PCB is in disorder.

The present invention is also provided for a liquid crystal display comprising a mounting structure of direct type backlight module light bar. Using the present mounding structure, the backlight emitting circuit of the liquid crystal display will be easy to connected and maintenance.

The present invention is also provided for a mounting method of the mounting structure of direct type backlight module light bar, wherein comprising the following processes:
Step 1) Inserting and connecting the plurality of light emitting modules 202 into the light bars 2;
Step 2) Welding the several groups light bars 2 on the PCB 1;
Step 3) Electrically connecting the inputting and the outputting of the light bars 2 to the PCB circuit strips 10 with the first connectors 101 of the PCB circuit strips 10 and the second connectors 201 of the light bars 2 correspondingly connecting, and then achieve the mounting structure of backlight module light bar.

In the present embodiment, the light emitting module 202 is LED. The series LED are inserted on the corresponding light bar 2. The number of the LED on the light bar is depend on the luminance requirement. The light bars 2 are in parallel and welding on the PCB 1. The second connectors 201 are respectively mounded on the inputting or the outputting of the light bar 2. The light bars 2 are assembled on the PCB circuit strips 10 with the connecting of the second connectors 201 and the first connectors 101 of the PCB circuit strips 10. The wire from the inputting and outputting can be uniformity in order and avoid the disorder of the wire.

The mounting structure of direct type backlight module light bar of the present invention comprises a PCB circuit strip separated from the PCB for storing the wire of the light bars uniformly. The wires which electrically connecting the light bars will be in order. The light bars can be electrically connecting to the PCB circuit strip with the connectors for achieving the fast assembling and disassembling of the light bars. The light bars can be illumined together. At the same time, each connector can be identified for the accurate assembling of the light bars. The light bar can be assembled on the PCB circuit strip correspondingly. With the uniform wiring, the circuit of the PCB can be simplified, so the light emitting modules can be fast disassembled or assembled, and then the mounding efficiency of the backlight module light bar and the rate of the good product will be improved.

What is claimed is:

1. A mounting structure of direct type backlight module light bar comprising a PCB and a plurality of light bars, wherein, two PCB circuit strips are provided for assembling at the two edges of the PCB, the PCB circuit strips are provided with a plurality of the first connectors assembled on, the light bars are provided with a plurality of the second connectors assembled on, the inputting and the outputting of the light bars assembled on the PCB circuit strips with the first connectors are connecting with the second connectors accordingly.

2. The mounting structure of direct type backlight module light bar according to claim 1, wherein the light bars are arranged in parallel with a plurality of light emitting modules assembled on.

3. The mounting structure of direct type backlight module light bar according to claim 2, wherein the PCB circuit strips are assembled at the edges of the PCB.

4. The mounting structure of direct type backlight module light bar according to claim 3, wherein the distance between every two light bars is equal.

5. The mounting structure of direct type backlight module light bar according to claim 4,
wherein the distance between two adjoining light bars is 52-58 mm.

6. The mounting structure of direct type backlight module light bar according to claim 3, wherein the first connectors are assembled at the same side of the PCB circuit strip.

7. The mounting structure of direct type backlight module light bar according to claim 2, wherein the light emitting modules are electrically connecting in series to each other.

8. The mounting structure of direct type backlight module light bar according to claim 2, wherein the light emitting modules are electrically connecting in parallel to each other.

9. The mounting structure of direct type backlight module light bar according to claim 2, wherein the light bars are assembled on the backside of the PCB.

10. A mounting method of the mounting structure of direct type backlight module light bar according to claim 1, wherein comprising the following processes:
1) inserting and connecting the plurality of light emitting modules into the light bars;
2) welding the several groups light bars on the PCB; and
3) electrically connecting the inputting and the outputting of the light bars to the PCB circuit strips with the first connectors of the PCB circuit strips and the second connectors of the light bars correspondingly connecting, and then achieve the mounting structure of backlight module light bar.

11. The mounting method of the mounting structure of direct type backlight module light bar according to claim 10, wherein the light bars are arranged in parallel with a plurality of light emitting modules, the distance between two adjoining light bars is 52-58 mm.

12. A liquid crystal display, wherein comprising a mounting structure of direct type backlight module light bar according to claim 1.
